(19) United States
(12) Patent Application Publication
(10) Pub. No.: US 2011/0216541 A1
(43) Pub. Date: Sep. 8, 2011

(54) Light source apparatus

(75) Inventors: Masaki Inoue, Hyogo (JP); Yutaka Shiozaki, Hyogo (JP); Koichi Kamei, Hyogo (JP)

(73) Assignee: USHIO DENKI KABUSHIKI KAISHA, Tokyo (JP)

(21) Appl. No.: 13/064,076

(22) Filed: Mar. 4, 2011

(30) Foreign Application Priority Data
Mar. 4, 2010 (JP) 2010-047581

(51) Int. Cl. F21V 7/07

(52) U.S. Cl. 362/296.09

(57) ABSTRACT

A light source apparatus that is used in a document reading apparatus that reads document-reflecting light from the document includes a first reflection mirror; a second reflection mirror; and a light guiding member that comprises a light emitting element mounted to one longitudinal end of the light guiding member and a light emitting face in a longitudinal direction, where the first and second reflection mirrors are arranged in parallel to the light guiding member and reflect light from the light emitting face of light guiding member toward a document placement face and where an end point of an optical axis of a first light reflection face is located on the document placement face between an end point of an optical axis of the first reflection mirror and an end point of an optical axis of the second reflection, mirror.

### CROSS-REFERENCES TO RELATED APPLICATION

This application claims priority from Japanese Patent Application Serial No. 2010-047581 filed Mar. 4, 2010, the contents of which are incorporated herein by reference in their entirety.

### TECHNICAL FIELD

The present invention relates to a light source apparatus used in devices such as a facsimile, copier, and scanner, for reading document.

### BACKGROUND

Devices such as a facsimile, copier, and scanner each include a document reading apparatus that reads characters and image information on a document face, using light reflected from the document face. The document reading apparatus is provided with a light source apparatus that illuminates the document face. Japanese Patent Application Publication No. 2008-216409 discusses an example of such a light source apparatus, which includes a rod-shape light guiding member with a light emitting element provided at one end and a reflection mirror arranged in parallel to the light guiding member.

FIG. 12 is a cross sectional diagram illustrating main units of a light source apparatus mounted to a document reading apparatus. In FIG. 12, a light source apparatus 80 is disposed below a document glass 5 where a document 2 is placed. The light source apparatus 80 includes a rod-shape light guiding member 81 extending in a main scanning direction (direction perpendicular to the plane of the figure), an elongated reflection mirror 87 extending in the main scanning direction in parallel to and at a distance from the light guiding member 81 across a document reading axis Y that is perpendicular to the document placement face 1, a holding member 88 holding the light guiding member 81, and a chassis 90 securing the light guiding member 81 and the reflection mirror 87. The light guiding member 81 has a light emitting element (not illustrated) at one end face (e.g., the one illustrated in FIG. 12). The light guiding member 81 has an outer circumference face including a light emitting face 82 along the longitudinal direction, the surface 82 having an arc shaped cross section in the direction perpendicular to the longitudinal direction. The circumference face further includes, opposite to the light emitting face 82, a first light reflection face 83 that reflects light from the light emitting element to the document placement face 1, and a second light reflection face 84 that reflects light from the light emitting element to the reflection mirror 87. The light guiding member 81 further includes holding protrusions 85 and 86 along the longitudinal direction.

In the light source apparatus 80, the light emitted from the light emitting element enters the corresponding end face of the light guiding member 81, and is guided along the light guiding member 81 in the main scanning direction. Simultaneously, the light is emitted from the light emitting face 82 toward the document placement face 1 and the reflection mirror 87 respectively by the first light reflection face 83 and the second light reflection face 84 of the light guiding member 81. The light emitted toward the reflection mirror 87 is then reflected by the reflection mirror 87 toward the document placement face 1. As described above, light from the light guiding member 81 on one side of the document reading axis Y (left side of FIG. 12) and light from the reflection mirror 87 on the other side of the document reading axis Y (right side of FIG. 12) illuminate the document 2 on the document placement face 1, so that an illuminated area of high illuminance that extends in the main scanning direction in a strip shape forms on one face of the document 2, which is used as effective illumination area that reads document information. In other words, document-reflecting light from the illuminated areas of high illuminance on one face of the document 2 is received by a charge coupled device (CCD) (not illustrated). The illuminated area of high illuminance on one face of the document 2 is relatively shifted along the document 2 in the sub-scanning direction, that is, in the direction perpendicular to the longitudinal direction of the light guiding member 81, so that necessary character and image information on the one face of the document 2 is read. The terms “illuminated areas of high illuminance” as used herein refer to an area having a predetermined illuminance, for example 90% or more of a maximum illuminance.

In a document reading apparatus having such a light source apparatus 80, an illuminated area of high illuminance provided by the light source apparatus 80 in the document placement face 1 needs to cover the entire scanning area scanned by a CCD, in the document placement face 1. In assembling such a document reading apparatus, however, it is difficult to arrange the light source apparatus 80 relative to a CCD with high positional accuracy. As a result, positional deviation occurs, in the document placement face 1, between a scanning area scanned by the CCD and an illuminated area of high illuminance by the light source apparatus 80, and thereby the illuminated area of high illuminance cannot cover the entire scanning area, which disturbs complete reading of the character and image information on the one face of the document 2 by the CCD. Because of the above situation, the light source apparatus 80 is required to form an illuminated area of high illuminance having a larger size, more specifically a larger width in the sub-scanning direction.

To form an illuminated area of high illuminance having a larger width in the sub-scanning direction, a light source apparatus may have a configuration in which a light guiding member and a reflection mirror are arranged such that, on a document placement face, the optical axis position of light from a light guiding member is further separated from the optical axis position of reflected light from a reflection mirror. The light source apparatus of such a configuration, however, has a problem. FIGS. 13A and 13B are graphs illustrating illuminance distribution in a sub-scanning direction on a document placement face in a conventional light source apparatus where the optical axis position of light from a light guiding member is apart from the optical axis position of reflected light from a reflection mirror. In the graphs, a vertical axis represents relative illuminance; a horizontal axis represents a position in the sub-scanning direction; a curve a represents an illuminance distribution of light from the first light reflection face of the light guiding member; a curve b represents a illuminance distribution of reflected light from the first reflection mirror; and a curve c represents an illuminance distribution of light from the overall apparatus. A point Y1 represents position of a document reading axis; an arrow a1 represents a light direction from the light guiding member relative to the document reading axis; and an arrow b1 represents the reflected light direction from the reflection mirror relative to the document reading axis. As illustrated in FIGS. 13A and 13B, when a light guiding member and a reflection mirror are arranged such that the optical axis position of light from the light guiding member is apart from the optical axis position of reflected light from the reflection mirror, an illuminated area of high illuminance R1 having a large width in the sub-scanning direction is formed. The illuminated area of high illuminance R1, however, includes a part that is illuminated by only one of the lights from the light guiding member and the reflected light from the reflection mirror, and the part is illuminated by light only from one side of the document reading axis, which causes shade when one face of the document 2 has unevenness. Consequently, only the area where the area illuminated from one side of the document reading axis by light from the light guiding member and the area illuminated from the other side of the document reading axis by reflected light from the reflection mirror overlap with each other can be used as an effective illumination area R2 to read a document. The area that cannot be used as the effective illumination area R2 totally occupies one-half of the area illuminated by light from the light guiding member and the area illuminated by reflected light from the reflection mirror, reducing the usage efficiency of the light.

### SUMMARY

The present invention was made in view of the above situation, and is directed to provide a light source apparatus used in a document reading apparatus that reads light reflected from a document, the light source apparatus being able to form an illuminated area of high illuminance having a large width in a sub-scanning direction and provide high usage efficiency of light.

Thus, a light source apparatus used in a document reading apparatus that reads document-reflecting light from the document, comprising: a first reflection mirror; a second reflection mirror; and a light guiding member that comprises: a light emitting element mounted to one longitudinal end of the light guiding member; and a light emitting face in a longitudinal direction, wherein the first and second reflection mirrors are arranged in parallel to the light guiding member and reflect light from the light emitting face of light guiding member toward a document placement face, wherein a first light reflection face that faces the light emitting face reflects light from the light emitting element toward the document placement face, wherein a second light reflection face that faces the light emitting face reflects the light from the light emitting element toward the first and second reflection mirrors, wherein an end point of an optical axis of the first light reflection face is located on the document placement face between an end point of an optical axis of the first reflection mirror and an end point of an optical axis of the second reflection mirror.

Further, the light source apparatus used in a document reading apparatus that reads document-reflecting light from document may include a third light reflection face that reflects light from the light emitting element toward the second reflection mirror.

Furthermore, in the light source apparatus, the first reflection mirror and the second reflection mirror are preferably arranged such that, on the document placement face, an area illuminated by reflected light from the first reflection mirror and an area illuminated by reflected light from the second reflection mirror partially overlap each other. Moreover, the light source apparatus may preferably include a chassis that secures and holds the light guiding member, the first reflection mirror, and the second reflection mirror, the chassis having a slit through which document-reflecting light from the document passes.

### BRIEF DESCRIPTION OF THE DRAWINGS

Other features and advantages of the present light source apparatus will be apparent from the ensuing description, taken in conjunction with the accompanying drawings, in which:

FIG. 1 is a cross sectional view illustrating a light source apparatus of one embodiment that is mounted to a document reading apparatus;

FIG. 2 is a perspective view illustrating a light guiding member, a first reflection mirror, and a second reflection mirror of the light source apparatus in FIG. 1;

FIG. 3 is a vertical sectional view illustrating a light guiding member of the light source apparatus in FIG. 1;

FIGS. 4A and 4B are graphs illustrating curves of illuminance distribution of light from the light source apparatus in FIG. 1 in a sub-scanning direction on a document placement face;

FIGS. 5A and 5B are graphs illustrating curves of illuminance distribution of light from the light source apparatus in FIG. 1 in a sub-scanning direction on a document placement face, in the case where a first reflection mirror and a second reflection mirror are arranged such that, on the document placement face, the optical axis position of light from the first reflection mirror is located between the optical axis position of light from a light guiding member and the optical axis position of light from the second reflection mirror;

FIG. 6 is a cross sectional view illustrating a light source apparatus of another embodiment that is mounted to a document reading apparatus and taken along a sub-scanning direction;

FIG. 7A is a cross sectional view illustrating a light source apparatus of another embodiment that is mounted to a document reading apparatus;

FIG. 7B is an enlarged cross sectional view illustrating the area A surrounded by dashed line in the light source apparatus. in FIG. 7A;

FIGS. 8A and 8B are graphs illustrating curves of illuminance distribution of light from the light source apparatus in FIGS. 7A and 7B in a sub-scanning direction on a document placement face;

FIG. 9 is a graph illustrating a curve of illuminance distribution of light in a sub-scanning direction on a document placement face in a light source apparatus (A) according to Example 1;

FIG. 10 is a graph illustrating a curve of illuminance distribution of light in a sub-scanning direction on a document placement face in a light source apparatus (B) according to Comparative Example 1;

FIG. 11 is a graph illustrating a curve of illuminance distribution of light in a sub-scanning direction on a document placement face in a light source apparatus (C) according to Comparative Example 1;

FIG. 12 is a cross sectional view illustrating the main parts of a light source apparatus mounted to a document reading apparatus; and

FIGS. 13A and 13B are graphs illustrating a curve of illuminance distribution of light in a sub-scanning direction on a document placement face, in a light source apparatus where a light guiding member and a reflection mirror are arranged such that the optical axis position of light from a light guiding member is disposed separately from the optical axis of reflected light from the reflection mirror.

### DESCRIPTION

In a light source apparatus according to the present invention, a first reflection mirror and a second reflection mirror are arranged such that an end point of an optical axis of the first light reflection face is located on the document placement face between an end point of an optical axis position of the first reflection mirror and an end point of an optical axis position of the second reflection mirror, and thereby, on document placement face, an area illuminated by light from the first light reflection face of the light guiding member includes a part on one side in the sub-scanning direction where an area illuminated by reflected light from the first reflection mirror is overlapped, and another part on the other side in the sub-scanning direction where an area illuminated by reflected light from the second reflection mirror is overlapped, which results in formation of an illuminated area of high illuminance having a large width in the sub-scanning direction. In addition, in the illuminated area of high illuminance, the area illuminated by only one of the reflected light from the first reflection mirror and the reflected light from the second reflection mirror, which can be an area with shade due to unevenness of the document, forms only part of the area illuminated by the reflected light from the first reflection mirror 20 and part of the reflected light from the second reflection mirror. Furthermore, the area illuminated from the one side of the document reading axis Y by the light from the first light reflection face of the light guiding member overlaps with the area illuminated from the other side of the document reading axis Y by light from the first reflection mirror and the area illuminated from the other side of the document reading axis Y by light from the second reflection mirror. Thus, the overall area illuminated by the light from the first light reflection face of the light guiding member can be used as an effective illuminated area to read document, which results in high usage efficiency of light. Since the first and second reflection mirrors are arranged such that, on the document placement face, the area illuminated by the reflected light from the first reflection mirror and the area illuminated by the reflected light from the second reflection mirror partially overlap each other, it is possible to prevent formation of an area only illuminated from one side of the document reading axis Y by the light from the first light reflection face of the light guiding member, that is an area with shade due to unevenness of the document, in the middle of the illuminated area of high illuminance in the sub-scanning direction.

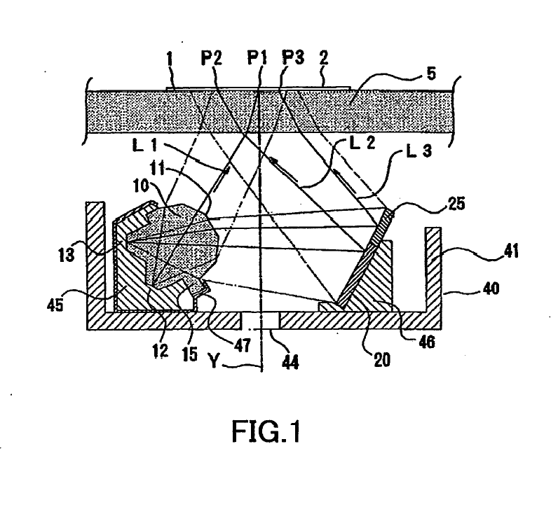

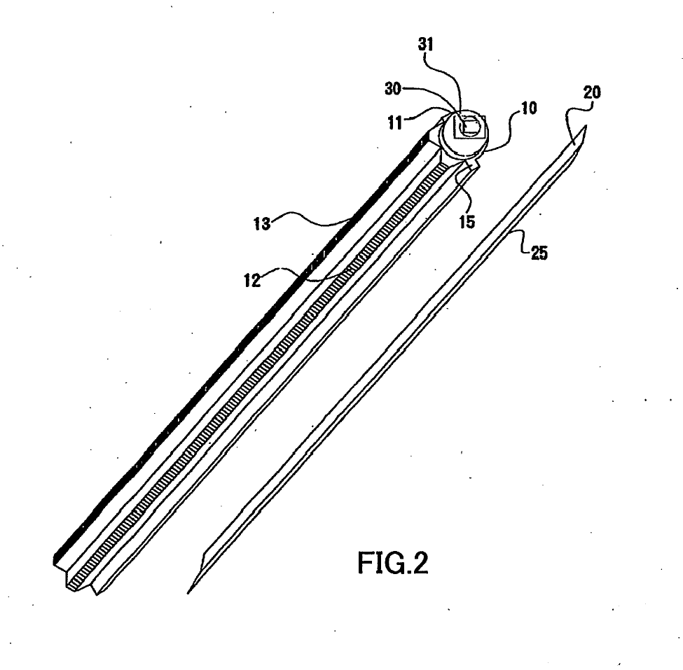

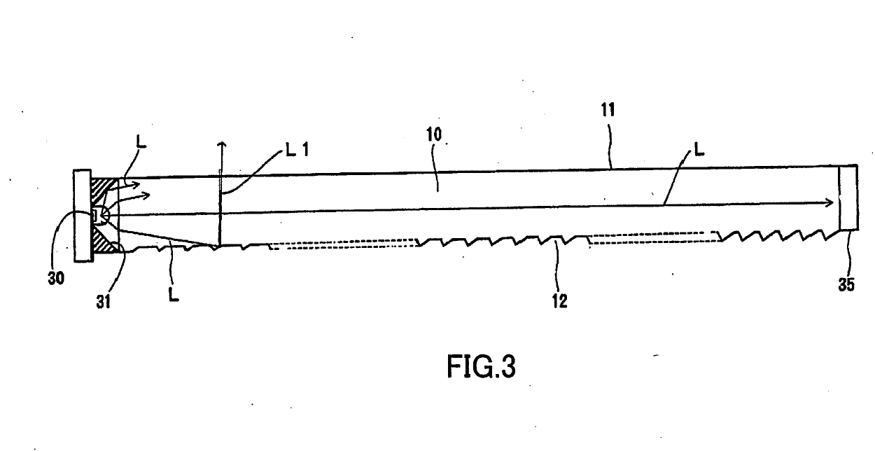

Embodiments of a light source apparatus according to the present invention are described below. FIG. 1 is a cross sectional view illustrating a light source apparatus of one embodiment that is mounted to a document reading apparatus. FIG. 2 is a perspective view illustrating a light guiding member, a first reflection mirror, and a second reflection mirror of the light source apparatus in FIG. 1. FIG. 3 is a vertical sectional view illustrating a light guiding member of the light source apparatus in FIG. 1. The light source apparatus is installed in a document reading apparatus under a light translucent document glass 5 where a document 2 is placed. The light source apparatus includes a rod-shape light guiding member 10 disposed along a plane parallel to a document placement face 1 of the document glass 5 and extending in a main scanning direction; first and second reflection mirrors 20 and 25 each in form of an elongated rectangular plate, the mirrors 20 and 24 being parallel to each other at a distance from the light guiding member 10 across a document reading axis Y that is perpendicular to the document placement face 1 and extending in the main scanning direction. In an example shown in the figure, the illustrated first and second reflection mirrors 20 and 25 are each a planar mirror, and are integrally formed by connecting the second reflection mirror 25 to an upper edge of the first reflection mirror 20. In the present invention, the terms “sub-scanning direction” refers to a shift direction of the light source apparatus relative to the document placement face 1, and the terms “main scanning direction” refers to the direction perpendicular to the sub-scanning direction and parallel to a document placement face. The light guiding member 10 has one end to which a light emitting element 30 is provided apart from the end face, and a mirror 31 is disposed to surround the space between the end face of the light guiding member 10 and the light emitting element 30. The light guiding member 10 has the other end having a face where a light diffusing and reflecting plate 35 is disposed to diffuse and reflect light received from the light emitting element 30.

The light guiding member 10 has an outer circumference face including a light emitting face 11 along the longitudinal direction, the face 11 having an arc shaped cross section in the direction perpendicular to the longitudinal direction. The circumference face further includes, opposite to the light emitting face 11, a first light reflection face 12 and a second light reflection face 13 along the longitudinal direction of the light guiding member 10. The first light reflection face 12 is configured with a group of micro-prisms on its surface to reflect light from the light emitting element 30 toward the document placement face 1. The second light reflection face 13 is separated at a distance from the first light reflection face 12, and reflects light from the light emitting element 30 toward the first and second reflection mirrors 20 and 25. In the illustrated embodiment, a holding protrusion 15 is provided between the light emitting face 11 and the first light reflection face 12 in the light guiding member 10 along the longitudinal direction of the light guiding member 10.

The light guiding member 10, the first reflection mirror 20, and the second reflection mirror 25 are each secured and held by a chassis 40. More specifically, the chassis 40 includes a square trough-like base 41, a light guiding member holding stand 45 provided on the base 41 and extending in the same direction as that of the light guiding member 10, and a reflection mirror holding stand 46 provided on the base 41 at a distance from the light guiding member holding stand 45 and extending in the same direction as that of the first and second reflection mirrors 20 and 25, and a guide fixing claw 47 sandwiched and held between the base 41 and the light guiding member holding stand 45. The holding protrusion 15 is fixed by the guide fixing claw 47 of the chassis 40, and thereby the light guiding member 10 is held and secured by the guiding member holding stand 45 with the light emitting face 11 facing to a predetermined direction, while the first and second reflection mirrors 20 and 25, which are connected to each other, are held by the reflection mirror holding stand 46, with the reflective surfaces of the mirrors each being oriented to a predetermined direction. The base 41 of the chassis 40 is provided with a slit that is located between the light guiding member holding stand 45 and the reflection mirror holding stand 46 and extends in the same direction as that of the light guiding member holding stand 45 and the reflection mirror holding stand 46, the slit passing document-reflecting light from the document 2 therethrough, so that document-reflecting light from the document 2 is received by a CCD for example, disposed below the light source apparatus.

The light guiding member 10 may be formed of acrylic resin, such as polymethyl methacrylate, cyclo olefin polymer, and cyclo olefin copolymer. When these materials are used, the light guiding member 10 can be made by injection molding. With respect to dimensions, for example, the light guiding member 10 has an overall length of 340 mm, the arc-shaped light emitting face 11 has a radius of 2.8 mm, the first light reflection face 12 has a width of 1.0 mm, and the second light reflection face 13 has a width of 1.0 mm.

The light emitting element 30 may be a white light emitting diode (LED). The light diffusing and reflecting plate 35 maybe made of a resin such as polyethylene terephthalate (PET) and polycarbonate (PC) containing titanic oxide, calcium carbonate, or glass beads, for example. The base 41 of the chassis 40 may be made of a metal, such as aluminum. The light guiding member holding stand 45 and the reflection mirror holding stand 46 may be made of a metal, such as aluminum or a resin such as polycarbonate.

In the light source apparatus, light L emitted from the light emitting element 30 and reflected by the mirror 31 enters the light guiding member 10 through one end face is reflected by the circumference face of the light guiding member 10 and guided in the longitudinal direction of the light guiding member 10, and also reflected by the first and second light reflection faces 12 and 13. The reflected light exits the light guiding member 10 through the light emitting face 11. The light L1 from the first light reflection face 12 illuminates one face of the document 2 placed on the document glass 5, and light from the second light reflection face 13 is reflected by the first and second reflection mirrors 20 and 25 as reflected light L2 and L3 respectively, which illuminate the one face of the document 2 placed on the document glass 5. In this way, in a light source apparatus of the present invention, the first and second reflection mirrors 20 and 25 are arranged such that, on the document placement face 1, the optical axis position P1 of the light L1 from the first light reflection face (an end point of an optical axis of the first light reflection face) is located between the optical axis position P2 of the reflected light L2 from the first reflection mirror 20 (an end point of an optical axis of the first reflection mirror) and the optical axis position P3 of the reflected light L3 from the second reflection mirror 25 (an end point of an optical axis of the second reflection mirror).

The terms “optical axis position” as used herein refers to a position having a highest illuminance in an illuminated area on a document placement face. More specifically, the terms “optical axis position of light from the first light reflection face” as used herein refers to a position having a highest illuminance in the area on a document placement face illuminated by light from the first light reflection face, the terms “optical axis position of reflected light from the first reflection mirror” as used herein refers to a position having a highest illuminance in the area on a document placement face illuminated by reflected light from the first reflection mirror, and the terms “the optical axis position of reflected light from the second reflection mirror” as used herein refers to a position having a highest illuminance in the area on a document placement face illuminated by reflected light from the second reflection mirror.

As set forth below, an optical axis position of light from the first light reflection face is obtained. The light source apparatus is turned on while any reflected light from the first and second reflection mirrors that illuminates a document placement face is blocked. The illuminance distribution over an illuminated area on the document placement face is measured, the area being formed by the light from the first reflection face of the light guiding member, so as to determine a position of the highest illuminance in the area. The optical axis position of reflected light from the first reflection mirror is obtained, as set forth below. The light source apparatus is lighted, and the illuminance distribution over an illuminated area on a document placement face is measured, wherein the area is formed by light from the first light reflection face of the light guiding member, reflected light from the first reflection mirror, and reflected light from the second reflection mirror (hereinafter, the measured illuminance distribution is referred to as first illuminance distribution). Then, while the light source apparatus is turned on and while reflected light from the first reflection mirror is blocked, the illuminance distribution over an illuminated area on the document placement face is measured. The illuminated area is formed by light from the first light reflection face of the light guiding member and light from the second reflection mirror (hereinafter, the measured illuminance distribution is referred to as second illuminance distribution). Using the difference between the first illuminance distribution and the second illuminance distribution, the illuminance distribution of the area on the document placement face illuminated by the reflected light from the first reflection mirror is measured to determine a position of the highest illuminance in the area.

The optical axis position of reflected light from the second reflection mirror is obtained as set forth below. The light source apparatus is turned on while reflected light from the second reflection mirror is blocked, and the illuminance distribution over an illuminated area on the document placement face is measured, the area being formed by light from the first light reflection face of the light guiding member and reflected light from the first reflection mirror (hereinafter, the measured illuminance distribution is referred to as third illuminance distribution). Using the difference between the first illuminance distribution and the third illuminance distribution, the illuminance distribution of the area on the document placement face illuminated by the reflected light from the second reflection mirror is measured to determine a position of the highest illuminance in the area.

The first and second reflection mirrors 20 and 25 are preferably arranged such that, on the document placement face 1, the illuminated area by the reflected light L2 from the first reflection mirror 20 and the area illuminated by the reflected light L3 from the second reflection mirror 25 partially overlap each other. The ratio between the distance from the optical axis position P1 of the light L1 from the first light reflection face 12 to the optical axis position P2 of the reflected light L2 from the first reflection mirror 20 and the distance from the optical axis position P1 of the light L1 from the first light reflection face 12 to the optical axis position P3 of the reflected light L3 from the second reflection mirror 25 is, for example, 1.

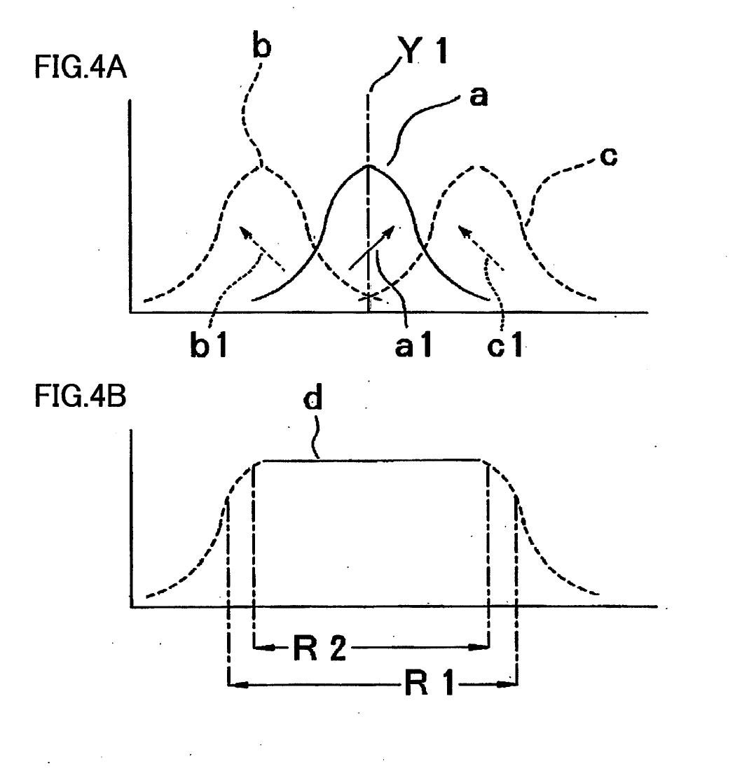

FIGS. 4A and 4B are graphs illustrating curves of illuminance distribution of light from the light source apparatus in FIG. 1 in the sub-scanning direction on a document placement face. In the graphs, a vertical axis represents relative illuminance, a horizontal axis represents a position in the sub-scanning direction, a curve a represents a illuminance distribution of light from the light guiding member, a curve b represents a illuminance distribution of light from the first reflection mirror, a curve c represents a illuminance distribution of light from the second reflection mirror, and a curve d represents a illuminance distribution of light from the overall apparatus. A point Y1 represents the position of a document reading axis, an arrow a1 represents the light direction from the light guiding member relative to the document reading axis, an arrow b1 represents the reflected light direction from the first reflection mirror relative to the document reading axis, and a arrow c1 represents the reflected light direction from the second reflection mirror relative to the document reading axis.

As illustrated in FIG. 4A, in the light source apparatus in FIG. 1, the area illuminated by the light L1 from the first light reflection face 12 of the light guiding member 10 (the illuminated area represented by the illuminance distribution curve a) is overlapped on one side in the sub-scanning direction, with an area that is illuminated by the reflected light L2 from the first reflection mirror 20 (the illuminated area represented by the illuminance distribution curve b), and is also overlapped on the other side in the sub-scanning direction, with an area illuminated by the reflected light L3 from the second reflection mirror 25 (the illuminated area represented by the illuminance distribution curve c). As a result, as illustrated FIG. 4B, the area illuminated by light from the overall light source apparatus (the illuminated area represented by the illuminance distribution curve d) results in an illuminated area of high illuminance (R1) that has a large width in the sub-scanning direction. In the illuminated area of high illuminance R1, the part where the area illuminated from the one side of the document reading axis Y (left side in FIG. 1) by the light L1 from the first light reflection face 12 of the light guiding member 10 and the area illuminated from the other side of the document reading axis Y (right side in FIG. 1) by the reflected light L2 from the first reflection mirror 20 or the area illuminated by the reflected light L3 from the second reflection mirror 25 overlap each other is illuminated by light from different directions relative to the document reading axis Y, that is, from one side and the other side of the document reading axis Y. Accordingly, even if the one face of the document 2 has unevenness, a shade is not formed in the part of the illuminated area of high illuminance R1, which can be used as an effective illumination area R2 to read document. It may be understood that, in the light source apparatus in FIG. 1, the overall area illuminated by the light L1 from the first reflection face of the light guiding member 10 is used, among the total illuminated areas by the light source apparatus, excluding only about one half of the area illuminated by the reflected light L2 from the first reflection mirror 20 and about one half of the area illuminated by the reflected light L3 from the second reflection mirror 25.

Consequently, according to the light source apparatus, because the first and second reflection mirrors 20 and 25 are arranged such that, on the document placement face 1, the optical axis position P1 of the light L1 from the first light reflection face 12 of the light guiding member 10 is located between the optical axis position P2 of the reflected light L2 from the first reflection mirror 20 and the optical axis position P3 of the reflected light L3 from the second reflection mirror 25, the area illuminated by the light L1 from the first light reflection face 12 of the light guiding member 10 includes a part on one side in the sub-scanning direction where the area illuminated by the reflected light L2 from the first reflection mirror 20 is overlapped, and another part on the other side in the sub-scanning direction where the area illuminated by the reflected light L3 from the second reflection mirror 25 is overlapped. This results in formation of an illuminated area of high illuminance having a large width in the sub-scanning direction on the document placement face 1. In addition, in the illuminated area of high illuminance, the area illuminated by only one of the reflected light L2 from the first reflection mirror 20 and the reflected light L3 from the second reflection mirror 25, which is the area with shade due to unevenness of the document 2, occupies only a part of the area illuminated by the reflected light L2 from the first reflection mirror 20 and a part of the area illuminated by the reflected light L3 from the second reflection mirror 25. Furthermore, the area illuminated from the one side of the document reading axis Y by the light from the first light reflection face 11 of the light guiding member 10 is overlapped with the area illuminated from the other side of the document reading axis Y by light from the first reflection mirror 20 or the area illuminated from the other side of the document reading axis Y by light from the second reflection mirror 25, and thereby the overall area illuminated by the light L1 from the first light reflection face 12 of the light guiding member 10 can be used as an effective illuminated area to read document, which results in high usage efficiency of light. Since the first and second reflection mirrors 20 and 25 are arranged such that, on the document placement face 1, the illuminated area by the reflected light L2 from the first reflection mirror 20 and the area illuminated by the reflected light L3 from the second reflection mirror 25 partially overlap each other, it is possible to prevent the formation of an area only illuminated from one side of the document reading axis Y by the light L1 from the first light reflection face 12 of the light guiding member 10, that is, an area with shade caused due to unevenness of the document 2, in the middle of the illuminated area of high illuminance in the sub-scanning direction.

A configuration, for example, in which the first and second reflection are arranged such that, on the document placement face 1, the optical axis position P2 of the reflected light L2 from the first reflection mirror 20 is located between the optical axis position P1 of the light L1 from the first light reflection face 12 of the light guiding member 10 and the optical axis position P3 of the reflected light L3 from the second reflection mirror 25 causes the following problem.

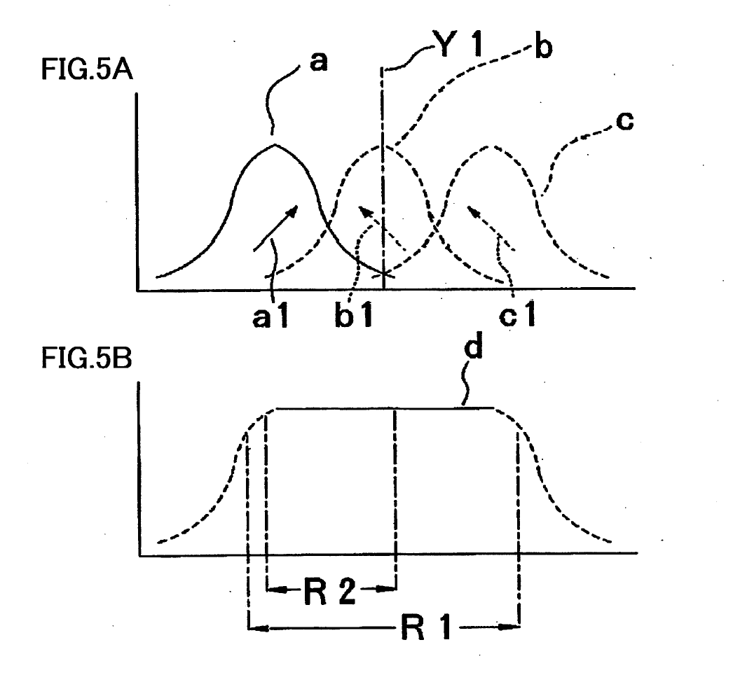

FIGS. 5A and 5B are graphs illustrating curves of illuminance distribution of light from a light source apparatus in the sub-scanning direction on a document placement face, in the case where a first reflection mirror and a second reflection mirror are arranged such that, on the document placement face, the optical axis position of light from the first reflection mirror is disposed between the optical axis position of light from a light guiding member and the optical axis position of reflected light from the second reflection mirror. In the graphs, a vertical axis represents relative illuminance, a horizontal axis represents a position in the sub-scanning direction, a curve a represents a illuminance distribution of light from a light guiding member, a curve b represents a illuminance distribution of light from the first reflection mirror, a curve c represents a illuminance distribution of light from the second reflection mirror, and a curve d represents a illuminance distribution of light from the overall apparatus. A point Y1 represents the position of a document reading axis, a arrow a1 represents the light direction from the light guiding member relative to the document reading axis, an arrow b1 represents the reflected light direction from the first reflection mirror relative to the document reading axis, and an arrow c1 represents the reflected light direction from the second reflection mirror relative to the document reading axis. As illustrated in FIG. 5A, an area illuminated by the reflected light L2 from the first reflection mirror 20 (the illuminated area represented by the illuminance distribution curve b) is overlapped on one side in the sub-scanning direction, with the area illuminated by the light L1 from the first light reflection face 12 of the light guiding member 10 (the illuminated area represented by the illuminance distribution curve a), and is also overlapped on the other side in the sub-scanning direction, with an area illuminated by the reflected light L3 from the second reflection mirror 25 (the illuminated area represented by the illuminance distribution curve c). As a result, as illustrated FIG. 5B, the area illuminated by light from the overall light source apparatus (the illuminated area represented by the illuminance distribution curve d) results in an illuminated area of high illuminance (R1) that has a large width in the sub-scanning direction. In the illuminated area of high illuminance R1, however, the area without shade due to unevenness of the document 2, which is an effective illumination area R2 to read document, only lies in the area where the area illuminated from one side of the document reading axis Y by the light L1 from the first light reflection face 12 of the light guiding member 10 overlaps the area illuminated from the other side of the document reading axis Y by the reflected light L2 from the first reflection mirror 20. Accordingly, the effective illumination area R2 has a small width in the sub-scanning direction, and most of the area illuminated by the reflected light L3 from the second reflection mirror 25 is not used, resulting in extremely low usage efficiency of light.

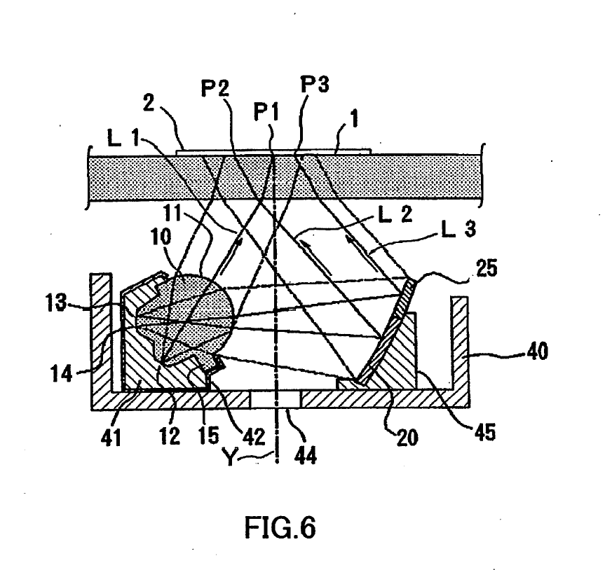

FIG. 6 is a cross sectional view illustrating a light source apparatus of another embodiment according to the present invention that is mounted to a document reading apparatus. The light guiding member 10, in FIG. 6, has an outer circumference face including a light emitting face 11 along the longitudinal direction, the face 11 having an arc shaped cross section in the direction perpendicular to the longitudinal direction. The circumference face further includes, opposite to the light emitting face 11, a first light reflection face 12, a second light reflection face 13, and a third light reflection face 14 along the longitudinal direction of the light guiding member 10. The first light reflection face 12 is configured with a group of micro-prisms on its surface to reflect light from the light emitting element 30 toward the document placement face 1. The second light reflection face 13 reflects light from the light emitting element 30 toward the first reflection mirror 20, and the third light reflection face 14 reflects light from the light emitting element 30 toward the second reflection mirror 25.

In the light source apparatus, light emitted from the light emitting element 30 and reflected by the mirror 31 (see FIGS. 2 and 3) enters the light guiding member 10 through one end face and is then reflected by the circumference face of the light guiding member 10 to be guided in the longitudinal direction of the light guiding member 10 and reflected by the first light reflection face 12, the second light reflection face 13, and the third light reflection face 14. The reflected light exits the light guiding member 10 through the light emitting face 11. The light L1 from the first light reflection face 12 illuminates one face of the document 2 placed on the document glass 5, the light L2 from the second light reflection face 13 is reflected by the first reflection mirror 20, and the light L3 from the third light reflection face 14 is reflected by the second reflection mirror 25. Each reflected light illuminates one face of the document 2 placed on the document glass 5. In this way, in this light source apparatus, the first and second reflection mirrors 20 and 25 are arranged such that, on the document placement face 1, the optical axis position P1 of the light L1 from the first light reflection face 12 is located between the optical axis position P2 of the reflected light L2 from the first reflection mirror 20 and the optical axis position P3 of the reflected light L3 from the second reflection mirror 25. The first and second reflection mirrors 20 and 25 are preferably arranged such that, on the document placement face 1, the illuminated area by the reflected light L2 from the first reflection mirror 20 and the area illuminated by the reflected light L3 from the second reflection mirror 25 partially overlap each other. The other basic configurations of this light source apparatus are similar to those of the light source apparatus in FIG. 1.

When the first and second reflection mirrors 20 and 25 are arranged such that, on the document placement face 1, the optical axis position P1 of the light L1 from the first light reflection face 12 of the light guiding member 10 is located between the optical axis position P2 of the reflected light L2 from the first reflection mirror 20 and the optical axis position P3 of the reflected light L3 from the second reflection mirror 25, the area illuminated by the light L1 from the first light reflection face 12 of the light guiding member 10 includes a part on one side in the sub-scanning direction where the area illuminated by the reflected light L2 from the first reflection mirror 20 is overlapped, and another part on the other side in the sub-scanning direction where the area illuminated by the reflected light L3 from the second reflection mirror 25 is overlapped. This results in formation of an illuminated area of high illuminance having a large width in the sub-scanning direction on the document placement face 1. In addition, in the illuminated area of high illuminance, the area illuminated by only one of the reflected light L2 from the first reflection mirror 20 and the reflected light L3 from the second reflection mirror 25, which is the area with shade due to unevenness of the document 2, occupies only a part of the area illuminated by the reflected light L2 from the first reflection mirror 20 and a part of the area illuminated by the reflected light L3 from the second reflection mirror 25. Furthermore, the area illuminated from the one side of the document reading axis Y by the light from the first light reflection face 11 of the light guiding member 10 is overlapped with the area illuminated from the other side of the document reading axis Y by light from the first reflection mirror 20 or the area illuminated from the other side of the document reading axis Y by light from the second reflection mirror 25, and thereby the overall area illuminated by the light L1 from the first light reflection face 12 of the light guiding member 10 can be used as an effective illuminated area to read the document, which results in high usage efficiency of light. Since the first and second reflection mirrors 20 and 25 are arranged such that, on the document placement face 1, the area illuminated by the reflected light L2 from the first reflection mirror 20 and the area illuminated by the reflected light L3 from the second reflection mirror 25 partially overlap, it is possible prevent the formation of an area only illuminated from one side of the document reading axis Y by the light L1 from the first light reflection face 12 of the light guiding member 10, that is an area with shade due to unevenness of the document 2, in the middle of the illuminated area of high illuminance in the sub-scanning direction.

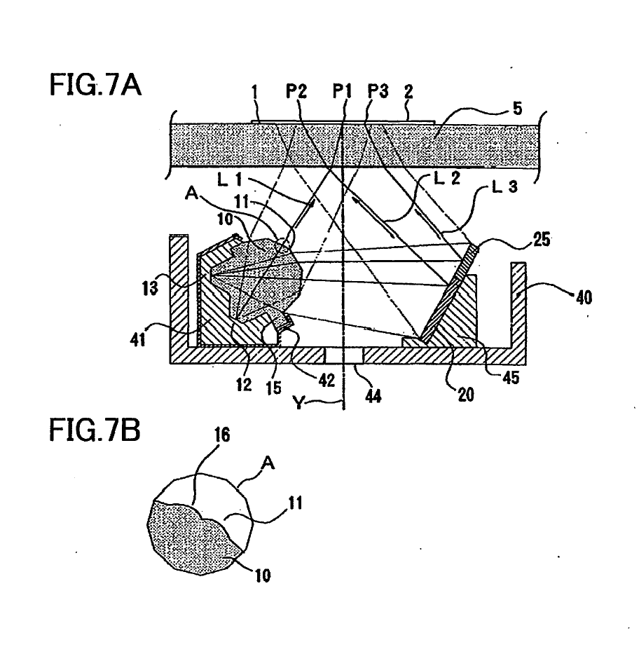

FIG. 7A is a cross sectional view illustrating a light source apparatus of another embodiment that is mounted to a document reading apparatus. FIG. 7B is an enlarged cross sectional view illustrating the area A surrounded by dashed line in the light source apparatus in FIG. 7A. The light source apparatus is, as illustrated in FIG. 7B, similar to the light source apparatus in FIG. 1, except that the light emitting face 11 of the light guiding member 10 includes a plurality of (two in FIG. 7A) convex portions 16 that are each located at a position where the optical axis of the light L1 from the first light reflection face 12 meets the light emitting face 11 and that each extend along the longitudinal direction of the light guiding member 10.

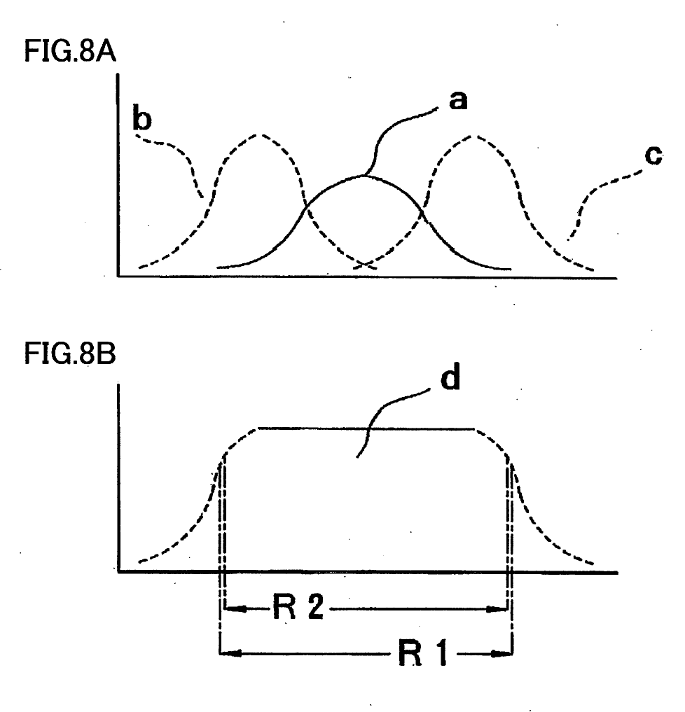

Such a light source apparatus provides the same effect as that obtained by the light source apparatus in FIG. 1, and further provides the following effect. FIGS. 8A and 8B are graphs illustrating curves of illuminance distribution of light from the light source apparatus in FIGS. 7A and 7B in a sub-scanning direction. In the graphs, a vertical axis represents relative illuminance, a horizontal axis represents a position in the sub-scanning direction, a curve a represents a illuminance distribution of light from the light guiding member, a curve b represents a illuminance distribution of reflected light from the first reflection mirror, a curve c represents a illuminance distribution of reflected light from the second reflection mirror, and a curve d represents a illuminance distribution of light from the overall apparatus. According to the light source apparatus of FIGS. 7A and 7B, because the light emitting face 11 of the light guiding member 10 includes the convex portions 16, the light L1 from the first light reflection face 12 of the light guiding member 10 is diffused when passing the light emitting face 11. Due to the diffusion, as illustrated in FIG. 8A, the area illuminated by the light L1 from the first light reflection face 12 (illuminated area represented by the illuminance distribution curve a) has a large width in the sub-scanning direction, and thereby the area illuminated by only one of the reflected light L2 from the first reflection mirror 20 and the reflected light L3 from the second reflection mirror 25, which can be an area with shade due to unevenness of the document 2, has a small width in the sub-scanning direction. This results in that the effective illumination area R2 covers a large proportion of the illuminated area of high illuminance R1, resulting in a further higher usage efficiency of light.

A light source apparatus of the present invention is not limited to those described above, and various modifications can be made. For example, the first and second reflection mirrors 20 and 25 may be separated from each other. The first and second reflection mirrors 20 and 25 maybe each a concave mirror that focuses light.

### Example 1

A white LED was used as a light emitting element, and the light source apparatus (A) illustrated in FIG. 1 was made according to the following conditions. A light guiding member (10) made of acrylic resin had an overall length of 340 mm. An arc-shaped light emitting face (11) had a radius of 2.8 mm, a first light reflection face (12) had a width of 1.0 mm, and a second light reflection face (13) had a width of 1.0 mm. The first reflection mirror (20) and the second reflection mirror (25) were each an elongated rectangular planer mirror. The first reflection mirror (20) had dimensions of 5.2 mm by 360 mm, and the second reflection mirror (25) had dimensions of 2.8 mm by 360 mm. Light was emitted from the light source apparatus (A) to illuminate the document placement face (1) located at a distance of 8 mm from the light guiding member (10) in the vertical direction, to measure illuminance distribution in a sub-scanning direction. In the document placement face (1), the distance from the optical axis position (P1) of light (L1) from the first light reflection face (11) of the light guiding member (10) to the optical axis position (P2) of reflected light (L2) from the first reflection mirror (20) was 2.5 mm, and the distance from the optical axis position (P1) of light (L1) from the first light reflection face (11) of the light guiding member (10) to the optical axis position (P3) from reflected light (L3) of the second reflection mirror (25) were also 2.5 mm.

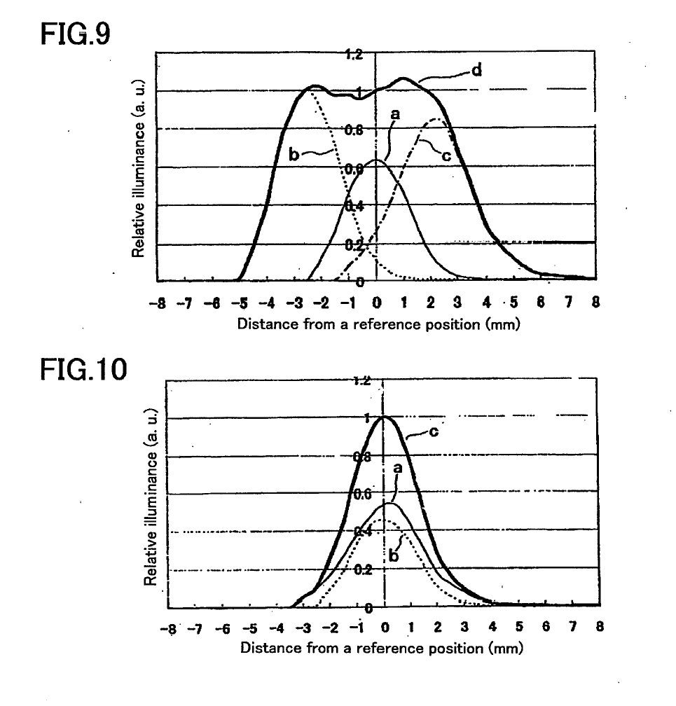

FIG. 9 is a graph illustrating a curve of illuminance distribution of light from the light source apparatus (A) in the sub-scanning direction on a document placement face, where a vertical axis represents relative illuminance, a horizontal axis represents a distance from a reference position on the document placement face, a curve a represents a illuminance distribution of light from a first light reflection face of a light guiding member, a curve b represents a illuminance distribution of reflected light from the first reflection mirror, a curve c represents a illuminance distribution of reflected light from the second reflection mirror, and a curve d represents a illuminance distribution of light from the overall apparatus. The graph shows that the light source apparatus (A) is configured so that the area illuminated by light from the first light reflection face of the light guiding member included a part on one side in the sub-scanning direction where an area illuminated by reflected light from the first reflection mirror was overlapped, and another part on the other side in the sub-scanning direction where an area illuminated by reflected light from the second reflection mirror was overlapped. In addition, the area illuminated by reflected light from the first reflection mirror and the area illuminated by reflected light from the second reflection mirror partially overlapped. The illuminated area of high illuminance (the area having illuminance 90% or more of a maximum illuminance) obtained by the light source apparatus (A) was measured, showing that the width of the area in the sub-scanning direction was 5.5 mm. The width of the area illuminated by the first light reflection face by the light guiding member overlapping the area illuminated by reflected light from the first reflection mirror and/or second reflection mirror, which is an effective illumination area without shade due to unevenness of the document, was measured to be 5.5 mm. The usage efficiency of light in the effective illumination area, among the illuminated area by the light source apparatus (A), for the light illuminating the document placement face was measured to be 80%. As described above, the light source apparatus (A) was found to provide an illuminated area of high illuminance having a large width in the sub-scanning direction, and high usage efficiency of light.

### Comparative Example 1

A white LED was used as a light emitting element, and the light source apparatus (B) illustrated in FIG. 12 was made according to the following conditions. A light guiding member (81) made of acrylic resin had an overall length of 340 mm. An arc-shaped light emitting face (82) had a radius of 2.8 mm, a first light reflection face (83) had a width of 1.0 mm, and a second light reflection face (84) had a width of 1.0 mm. A reflection mirror (87) used an elongated rectangular planer mirror, and had dimensions of 8 mm by 360 mm. Light was emitted from the light source apparatus (B) to illuminate the document placement face (1) disposed at a distance of 8 mm from the light guiding member (81) in the vertical direction, to measure illuminance distribution in the sub-scanning direction. The reflection mirror (87) was arranged such that, on the document placement face (1), the optical axis position of reflected light from the reflection mirror (87) coincided with the optical axis position of light from the first reflection face (82) of the light guiding member (81).

FIG. 10 is a graph illustrating a curve of illuminance distribution of light from the light source apparatus (B) in the sub-scanning direction on a document placement face, where a vertical axis represents relative illuminance, a horizontal axis represents a distance from a reference position on the document placement face, a curve a represents a illuminance distribution of light from the first light reflection face of the light guiding member, a curve b represents a illuminance distribution of reflected light from the first reflection mirror, and a curve c represents a illuminance distribution of light from the overall apparatus. The graph shows that the light source apparatus (B) was configured so that the area illuminated by reflected light from the reflection mirror completely covered the area illuminated by light from the first light reflection face of the light guiding member. The illuminated area of high illuminance (the area having illuminance 90% or more of a maximum illuminance) obtained by the light source apparatus (B) was measured, showing that the width of the area in the sub-scanning direction was 1.1 mm, which was a small value.

### Comparative Example 2

A light source apparatus (C) made to have similar configurations as those of Comparative Example 1, except that the distance on the document placement face (1) from the reflection mirror (87), was arranged such that the distance between the optical axis of reflected light from the reflection mirror (87) to the optical axis position of light from the first reflection face (83) of the light guiding member (81) was set to be 3 mm. Light was emitted from the light source apparatus (C) to illuminate the document placement face (1) disposed at a distance of 8 mm from the light guiding member (81) in the vertical direction, and illuminance distribution in the sub-scanning direction was measured.

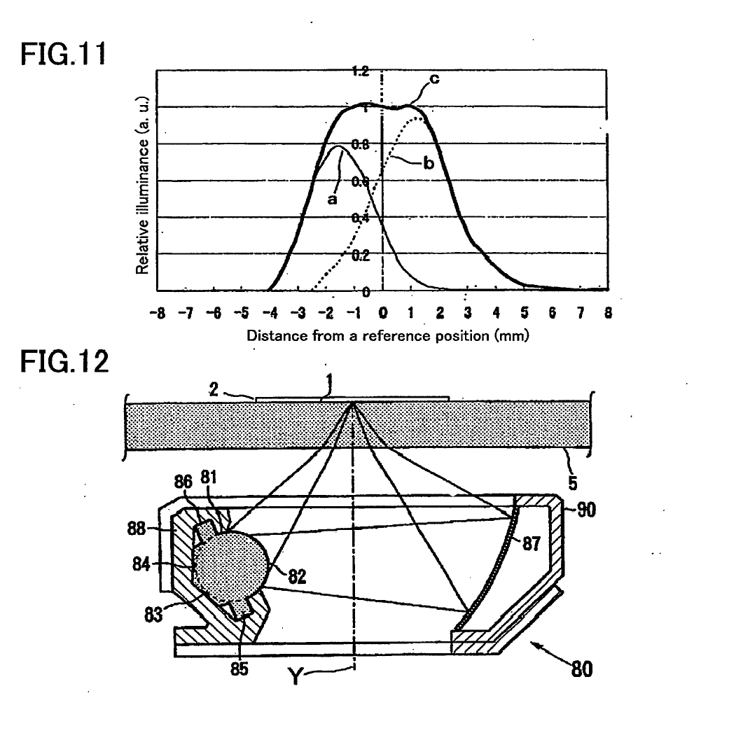

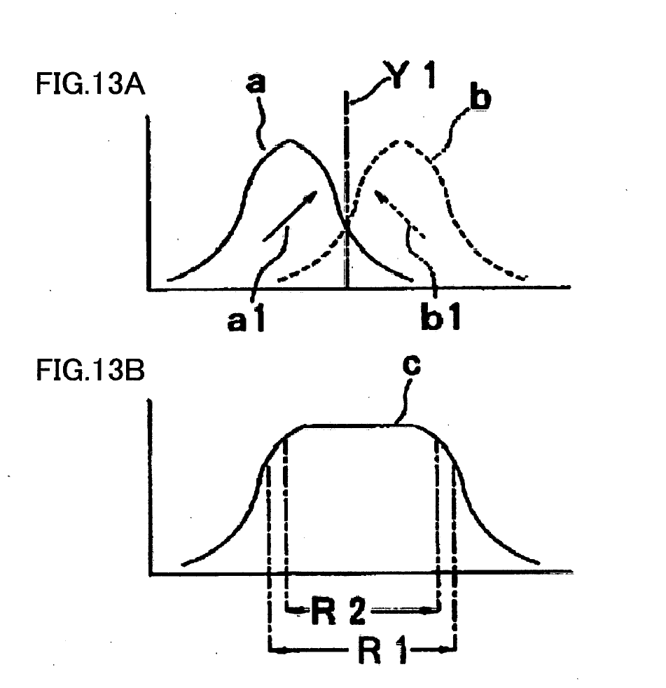

FIG. 11 is a graph illustrating a curve of illuminance distribution of light from the light source apparatus (C) in the sub-scanning direction on a document placement face, where a vertical axis represents relative illuminance, a horizontal axis represents a distance from a reference position on the document placement face, a curve a represents a illuminance distribution of light from the first light reflection face of the light guiding member, a curve b represents a illuminance distribution of reflected light from the first reflection mirror, and a curve c represents a illuminance distribution of light from the overall apparatus. The graph shows that the light source apparatus (C) was configured so that the area illuminated by reflected light from the reflection mirror and the area illuminated by light from the first light reflection face of the light guiding member partially overlapped each other. The illuminated area of high illuminance (the area having illuminance 90% or more of a maximum illuminance) obtained by the light source apparatus (C) was measured, showing that the width of the area in the sub-scanning direction was 3.4 mm, which proved that an illuminated area of high illuminance having a large width in the sub-scanning direction was formed. However, the area illuminated by light from the first light reflection face of the light guiding member overlapping the area illuminated by reflected light from the reflection mirror, which is an area without shade due to unevenness of the document, was measured, showing that the area had a width of 3.4 mm. The usage efficiency of light in the effective illumination area among the illuminated area by the light source apparatus (C) was measured to be 60%, which is not enough for high usage efficiency of light.

The preceding description has been presented only to illustrate and describe exemplary embodiments of the present light source apparatus. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A light source apparatus used in a document reading apparatus that reads document-reflecting light from the document, comprising:
a first reflection mirror;
a second reflection mirror; and
a light guiding member that comprises:
a light emitting element mounted to one longitudinal end of the light guiding member;
a light emitting face in a longitudinal direction;
a first light reflection face that faces the light emitting face reflects light from the light emitting element toward the document placement face; and
a second light reflection face that faces the light emitting face reflects the light from the light emitting element toward the first and second reflection mirrors;
wherein the first and second reflection mirrors are arranged in parallel to the light guiding member and reflect the light from the light emitting face of light guiding member toward a document placement face,
wherein an end point of an optical axis of the first light reflection face is located on the document placement face between an end point of an optical axis of the first reflection mirror and an end point of an optical axis of the second reflection mirror.

2. A light source apparatus used in a document reading apparatus that reads document-reflecting light from document, comprising:
a first reflection mirror;
a second reflection mirror; and
a light guiding member that comprises:
a light emitting element mounted to one longitudinal end of the light guiding member;
a light emitting face in a longitudinal direction;
a first light reflection face that faces the light emitting face reflects light from the light emitting element toward the document placement face; and
a second light reflection face that faces the light emitting face reflects the light from the light emitting element toward the first and second reflection mirrors;
wherein the first and second reflection mirrors are arranged in parallel to the light guiding member and reflect light from the light emitting face of light guiding member toward a document placement face,
wherein a third light reflection face reflects light from the light emitting element toward the second reflection mirror,
wherein an end point of an optical axis of the first light reflection face is located on the document placement face between an end point of an optical axis of the first reflection mirror and an end point of an optical axis of the second reflection mirror.

3. The light source apparatus according to claim 1, wherein, on the document placement face, an area illuminated by reflected light from the first reflection mirror and an area illuminated by reflected light from the second reflection mirror partially overlap.

4. The light source apparatus according to claim 2, wherein, on the document placement face, an area illuminated by reflected light from the first reflection mirror and an area illuminated by reflected light from the second reflection mirror partially overlap.

5. The light source apparatus according to claim 1, further comprising a chassis that secures the light guiding member, the first reflection mirror, and the second reflection mirror and comprises a slit, wherein light from the document passes the slit.

6. The light source apparatus according to claim 2, further comprising a chassis that secures the light guiding member, the first reflection mirror, and the second reflection mirror and comprises a slit, wherein light from the document passes the slit.
